(19) United States
(12) Patent Application Publication
(10) Pub. No.: US 2013/0112280 A1
(43) Pub. Date: May 9, 2013

(54) AUTOMATIC GATE VALVE FOR HOT MELT ADHESIVE LINES

(71) Applicant: GRACO MINNESOTA INC., Minneapolis, MN (US)

(72) Inventors: Paul R. Quam, Brooklyn Center, MN (US); Daniel P. Ross, Maplewood, MN (US)

(73) Assignee: GRACO MINNESOTA INC., Minneapolis, MN (US)

(21) Appl. No.: 13/671,193

(22) Filed: Nov. 7, 2012

Related U.S. Application Data
(60) Provisional application No. 61/556,574, filed on Nov. 7, 2011.

(51) Int. Cl. F16L 53/00

(52) U.S. Cl. CPC F16L 53/00
USPC 137/13; 137/334

(57) ABSTRACT

A hot melt system includes a melt system, a feed system, a dispensing system, and a pump. The melt system melts the pellets to produce a liquid, and the pump delivers the liquid to the dispensing system. The feed system is coordinated with the operation of the pump to control the amount of pellets delivered to the melt system.

### CROSS-REFERENCE TO RELATED APPLICATION

This application claims priority to U.S. Provisional Application No. 61/556,574, filed on Nov. 7, 2011, and entitled “AUTO GATE VALVE,” the disclosure of which is incorporated by reference in its entirety.

### BACKGROUND

The present disclosure relates generally to systems for dispensing hot melt adhesive. More particularly, the present disclosure relates to a feed system for admitting hot melt pellets to the melt system.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a feed system of a hot melt system is coordinated with operation of a pump so that hot melt solids are delivered to the hot melt system as a function of a rate at which hot melt liquid is being pumped.

### BRIEF DESCRIPTION OF THE DRAWINGS

FIG. 1 is a block diagram of a hot melt adhesive system.

FIG. 2 is a perspective view of a dispenser, pump, and melt system of the hot melt adhesive system of FIG. 1.

### DETAILED DESCRIPTION

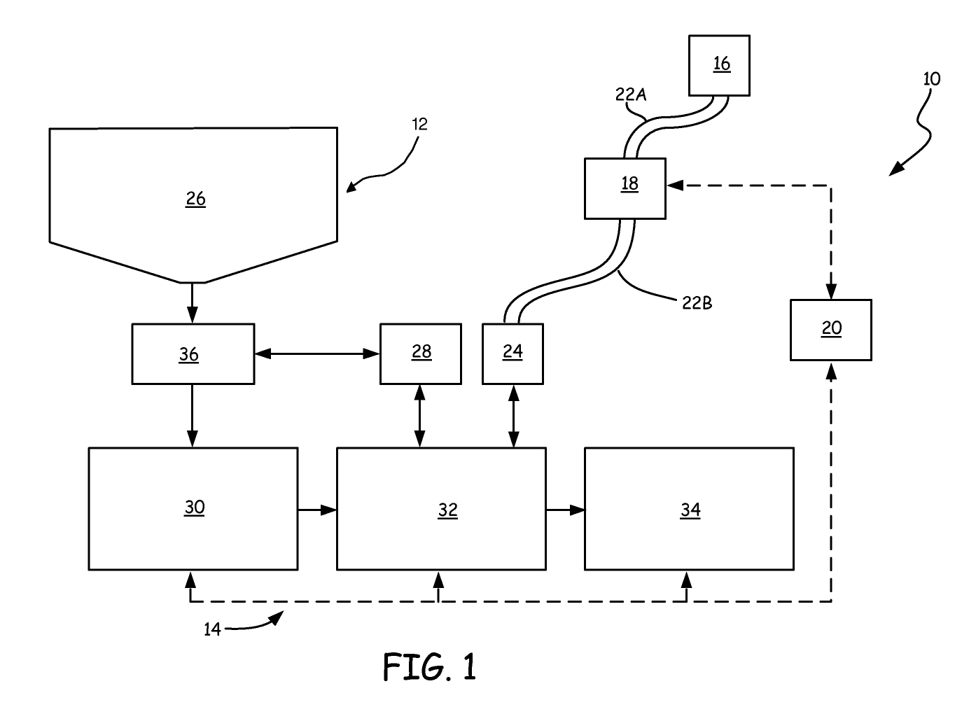

FIG. 1 shows system 10, which dispenses hot melt adhesive. System 10 includes cold section 12, hot section 14, air source 16, air control valve 18, controller 20, air hoses 22A and 22B, and motor 24. In the embodiment shown in FIG. 1, cold section 12 includes container 26 and valve system 28. Hot section 14 includes melt system 30, pump 32, and dispenser 34. Air source 16 is a source of compressed air supplied to air motor 24, which drives pump 32. Air control valve 18 is connected to air source 16 via air hose 22A, and selectively controls air flow from air source 16 through air hose 22B to motor 24 of pump 32. Controller 20 is connected in communication with various components of system 10, such as air control valve 18, melt system 30, pump 32, and/or dispenser 34, for controlling operation of system 10. System 10 also includes valve 36. Valve 36 may be a gate valve or other valve capable of selectively admitting hot melt pellets to melt system 30 from container 26.

Components of cold section 12 can be operated at room temperature, without being heated. Container 26 can be a hopper for containing a quantity of solid adhesive pellets for use by system 10. Suitable adhesives can include, for example, a thermoplastic polymer adhesive such as ethylene vinyl acetate (EVA) or metallocene. Valve system 28 connects container 26 to hot section 14 for delivering the solid adhesive pellets from container 26 to hot section 14.

Solid adhesive pellets are delivered from container 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 24 to pump hot melt adhesive from melt system 30 to dispenser 34. Motor 24 can be an air motor driven by pulses of compressed air from air source 16 and air control valve 18. Pump 32 can be a linear displacement pump driven by motor 24. In various embodiments, dispenser 34 may include a manifold and dispensing modules. Dispenser 34 can selectively discharge hot melt adhesive onto an object, such as a package, a case, or another object benefiting from hot melt adhesive dispensed by system 10. In some embodiments, dispenser 34 can be a handheld gun-type dispenser, for example. Some or all of the components in hot section 14, including melt system 30, pump 32, and dispenser 34, can be heated to keep the hot melt adhesive in a liquid state throughout hot section 14 during the dispensing process. System 10 can be part of an industrial process, for example, for packaging and sealing cardboard packages and/or cases of packages.

Valve system 28 is a mechanism for replenishing melt system 30. In alternative embodiments, valve system 28 may be replaced by any type of valve or other device which is capable of selectively admitting defined quantities of adhesive pellets from container 26. By mechanically coupling valve system 28 to pump 32 and valve 36, valve system 28 may drive valve 36 to admit a quantity of pellets from container 26 sufficient to replenish melt system 30 on each cycle of pump 32. Where pump 32 draws the same quantity of liquefied adhesive on each cycle, the quantity of pellets admitted by valve system 28 may be equal to the quantity of liquefied adhesive drawn by pump 32.

As pump 32 is driven by motor 24, liquefied adhesive is transferred from melt system 30 through pump 32 to dispenser 34. In order to minimize char of the liquefied adhesive, the quantity of liquefied adhesive in melt system 30 should be minimized. However, there must be sufficient liquefied adhesive available in melt system 30 for each cycle of pump 32 to draw. Thus, valve system 28 admits to melt system 30 an amount of pellets from container 26 sufficient to replenish the melted adhesive drawn by pump 32. This may be accomplished by mechanically coupling valve 36 to valve system 28, which is in turn mechanically coupled to pump 32.

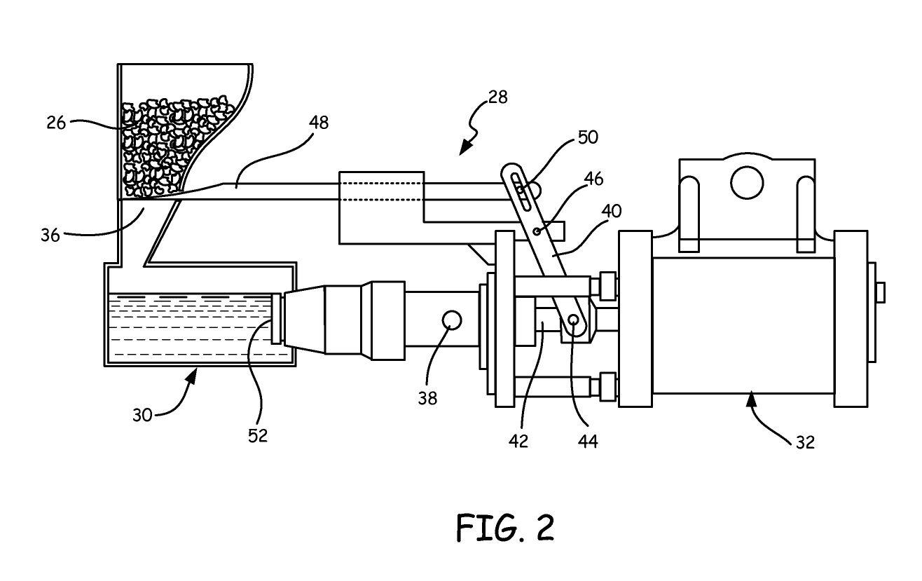

FIG. 2 is a perspective view of an embodiment of the invention, showing portions of cold section 12 and hot section 14. The embodiment shown in FIG. 2 shows many of the same components as laid out in FIG. 1, including container 26, valve system 28, melt system 30, and pump 32. As shown in FIG. 2, container 26 is a dry goods hopper. Container 26 may be used to hold unmelted hot melt pellets. Melt system 30 is shown as a tank of melted adhesive. In other embodiments, melt system 30 may be a small container with resistive heating elements as described above. Motor 24 may be, for example, an air motor or an electric motor, or any other motor capable of driving pump 32 in a reciprocating fashion. Dispenser 34 (FIG. 1) connects to outlet port 38. In alternative embodiments, the dispenser may be made up of additional parts which direct liquefied adhesive towards desired targets.

As pump shaft 42 moves to the right (with respect to FIG. 2), pump linkage 40 is moved at shaft-linkage connection 44. Pump linkage 40 pivots counterclockwise about pivot 46, pushing valve linkage 48 to the left (with respect to FIG. 2) via sliding connector 50, causing valve 36 to close off container 26 from melt system 30. Conversely, when pump shaft 42 moves to the left, pump linkage 40 pivots clockwise about pivot 46, pulling valve linkage 48 to the right via sliding connector 50, and causing valve 36 to open. Thus, because container 26 is above melt system 30, gravity causes pellets to fall into melt system 30.

In the embodiment shown in FIG. 2, melt system 30 is connected to container 26 by way of valve system 28. Valve system 28 and melt system 30 are both connected to pump 32. The inlet for pump 32 connects to the outlet of melt system 30 at interface 52. Valve system 28 is connected to pump 32 by way of pump linkage 40. Pump 32 is also connected to motor 24. FIG. 2 shows one example of pump linkage 40. As shown in FIG. 2, pump linkage 40 is a direct mechanical linkage including a pivot. Pump linkage 40 mechanically connects pump 32 to valve system 28.

In the embodiment shown in FIG. 2, valve system 28 opens when pump 32 moves in one direction, and closes when pump 32 moves in the other direction, due to pump linkage 40. In the embodiment shown in FIG. 2, this coupling of valve system 28 and pump 32 results in additional hot melt pellets being added to melt system 30 each time pump 32 transfers liquefied adhesive to dispenser 34. In other embodiments, pump linkage 40 may cause valve system 28 to add hot melt pellets at other times in response to movement of pump 32. For example, valve system 28 could be opened by pump linkage 40 at the other end of the movement of pump 32 by eliminating the pivot point shown pump linkage 40 of the embodiment shown in FIG. 2. Many other embodiments of pump linkage 40 are possible, so long as the periodic movement of pump 32 results in a corresponding or related periodic opening and closing of valve system 28. Pump linkage 40 coordinates the movement of pump 32 to the feed rate of unmelted pellets through valve system 28.

The pairing of valve system 28 with pump 32 by pump linkage 40 allows system 10 to admit the proper amount of unmelted hot melt pellets without complex systems for measuring them. By adjusting the size of valve 36 and how long valve system 28 remains open for each stroke of pump 32, a quantity of hot melt pellets is added to melt system 30 via valve system 28 that is roughly equal to the quantity of hot melt adhesive that is removed from melt system 30 via pump 32. Accordingly, no measurement system is required to determine when and how many hot melt pellets must be added to melt system 30 during use.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt system comprising:
a melt system for heating hot melt pellets into a liquid;
a dispensing system for administering the liquid;
a pump for pressurizing the liquid between the melt system and the dispensing system; and
a feed system, coordinated with the operation of the pump, for delivering hot melt pellets to the melt system.

2. The hot melt system of claim 1, wherein the pump and the feed system are both connected to a motor.

3. The hot melt system of claim 1, further comprising a container for storing hot melt pellets, wherein the feed system delivers hot melt pellets from the container to the melt system.

4. The hot melt system of claim 3, wherein the feed system is coordinated with the operation of the pump through a mechanical linkage.

5. The hot melt system of claim 4, wherein the feed system includes a valve.

6. The hot melt system of claim 5, wherein the valve is configured to open each time the pump cycles.

7. The hot melt system of claim 4, wherein the mechanical linkage causes the feed system to allow pellets to pass from the container to the melt system on each pump cycle.

8. The hot melt system of claim 3, wherein the container is arranged above the feed system, and the feed system is arranged above the melt system.

9. A method of processing hot melt adhesive, the method comprising:
liquefying hot melt adhesive pellets in a melt system;
pumping a first quantity of liquefied hot melt adhesive from the melt system to a dispenser with a pump; and
replenishing the melt system with a second quantity of hot melt pellets from a container to the melt system in response to the pumping of the first quantity of liquefied hot melt adhesive.

10. The method of claim 9 wherein the pump is a reciprocating piston pump.

11. The method of claim 10, and further comprising moving a linkage in tandem with the reciprocating piston pump to replenish the melt system.

12. The method of claim 11, wherein replenishing the melt system includes opening and closing a valve in coordination with the movement of the linkage to allow the second quantity of hot melt pellets to enter the melt system.

13. The method of claim 12, wherein the valve is connected to the pump via the linkage.

14. The method of claim 12 wherein the valve is a gate valve.

15. A hot melt system comprising:
a melt system capable of heating the hot melt pellets into a liquid;
a dispensing system for administering the liquid;
a pump for pressurizing the liquid between the melt system and the dispensing system; and
a feed system for transporting hot melt pellets to the melt system, the feed system configured to transport a quantity of hot melt pellets to the melt system in mechanical coordination with operation of the pump.

16. The hot melt system of claim 15, wherein the pump is a reciprocating piston pump.

17. The hot melt system of claim 16, and further comprising a linkage connected to the reciprocating piston pump such that the linkage and the reciprocating piston pump move in tandem.

18. The hot melt system of claim 14 wherein the feed system includes a valve that controls flow of hot melt pellets to the melt system.

19. The hot melt system of claim 18 further comprising a container arranged above the valve, and the valve arranged above the melt system, such that when the valve is opened the hot melt pellets fall into the melt system from the container.

20. The hot melt system of claim 18 wherein the valve and the linkage are configured so that the valve opens once per cycle of the pump.
